(19) United States
(12) Patent Application Publication
(10) Pub. No.: US 2005/0128877 A1
(43) Pub. Date: Jun. 16, 2005

(54) Alarm electronic timepiece and conductive spring

(76) Inventors: Morinobu Endo, Suzaka-shi (JP); Tetsuo Uchiyama, Tokyo (JP); Akio Yamaguchi, Kasugai-shi (JP); Yasuo Kondo, Toyota-shi (JP); Hiroshi Aoyama, Nagoya-shi (JP); Koichiro Jujo, Kisarazu-shi (JP); Kazutoshi Takeda, Sakura-shi (JP); Masato Takenaka, Misato-shi (JP); Shigeo Suzuki, Ichikawa-shi (JP); Takeshi Tokoro, Tokyo (JP)

Correspondence Address: Steve J Grossman;Grossman Tucker Perreault & Pfleger, 55 South Commercial Street, Manchester, NH, 03101, US

(21) Appl. No.: 10/499,451

(22) PCT Filed: Dec. 20, 2002
(86) PCT No.: PCT/JP02/13401

(30) Foreign Application Priority Data
Dec. 21, 2001 (JP) 2001-390280

(51) Int. Cl. G04C 21/00; G04C 23/00

(52) U.S. Cl. 368/73

(57) ABSTRACT

The present invention relates to an electronic timepiece. Moreover, the present invention relates to a conductive spring which can be used in an alarm electronic timepiece, or the like. Also the present invention is constituted to include one or more curved sections so as to be deformable, and constitutes a conductive spring formed from a filler containing resin. Alternatively it constitutes an electronic timepiece in which this conductive spring is used for transferring a buzzer signal. Furthermore it constitutes a conductive part comprising this conductive spring and a housing which retains the conductive spring.

### TECHNICAL FIELD

The present invention relates to an electronic timepiece. Moreover, the present invention relates to a conductive spring which can be used in an alarm electronic timepiece, or the like.

### BACKGROUND ART

Referring to FIG. 11, in a conventional first type of alarm electronic timepiece, a movement 700 comprises a main plate 702. A dial 706 is arranged at the back side of the main plate 702. In this movement 700, a signal output pattern for outputting a piezobuzzer drive signal is provided on the surface of a circuit board 712. A signal input pattern for inputting a piezobuzzer drive signal is provided on a piezobuzzer 742 arranged inside of a case back 740. A conductive coiled spring 716 for electrically connecting the signal output pattern on the circuit board 712 and the signal input pattern on the piezobuzzer 742, is provided in the movement 700. One end of the conductive coiled spring 716 is arranged so as to contact with the signal output pattern on the surface of the circuit board 712. The conductive coiled spring 716 is formed from a conductive material such as stainless steel. A guiding section 710 for guiding the conductive coiled spring 716 is provided in a battery frame 710. A window section 714a for clearance from the conductive coiled spring 716 is provided in a switch spring 714. The guiding section 710c includes a cylindrical part and a truncated conical part. The conductive coiled spring 716 is located by providing the guiding section 710c.

Referring to FIG. 12, in a conventional second type of alarm electronic timepiece, in a movement 750, a signal output pattern for outputting a piezobuzzer drive signal is provided on the back face of a circuit board 712. A signal input pattern for inputting a piezobuzzer drive signal is provided on a piezobuzzer 742 arranged inside of a case back 740. A conductive plate spring 770 for electrically connecting the signal output pattern on the circuit board 712 and the signal input pattern on the piezobuzzer 742, is provided in the movement 750. The conductive plate spring 770 comprises a base section 770a and a contact point spring section 770b. The base section 770a is arranged between the circuit board 712 and a battery frame 760. That is, the base section 770a is arranged so as to contact with the signal output pattern on the back face of the circuit board 712. A tip of the contact point spring section 770b contacts with the signal input pattern. The conductive plate spring 770 is formed from a conductive material such as stainless steel. A guiding section 760c for guiding the conductive plate spring 770 is provided on the battery frame 760. A window section 764a for clearance from the conductive plate spring 770 is provided in a switch spring 764. The guiding section 760c includes a cylindrical part and a truncated conical part. The conductive plate spring 770 is located by providing the guiding section 760c.

However, in a conventional first type of alarm electronic timepiece, if a movement comprising a conductive coiled spring for transferring a signal to a piezobuzzer is incorporated in an exterior case having a screw type (rotation installation type) case back, as shown by imaginary lines in FIG. 11, due to the rotation of the case back, the conductive coiled spring may fall, causing a defect in the electrical connection. Moreover, in a conventional second type of alarm electronic timepiece, if a movement comprising a stainless conductive plate spring for transferring a signal to a piezobuzzer is incorporated in an exterior case having a screw type case back, due to the tip of the conductive plate spring, the signal input pattern on the piezobuzzer may be scraped away. Furthermore, when a movement comprising a stainless conductive plate spring is fitted to an exterior case having a screw type case back, if the longitudinal direction of the conductive plate spring is not formed in the tangential direction of the circumference and the concentric circle of the case back, the conductive plate spring may be distorted, causing a defect in the electrical connection between the conductive plate spring and the signal input pattern.

Furthermore, when a movement comprising a stainless conductive plate spring is fitted to an exterior case having a screw type case back, the conductive plate spring may be buckled. Moreover, in a movement comprising a conductive coiled spring, if a conductive coiled spring is arranged at the center of a movement, there are problems in that it becomes difficult to mount a lithium battery of a diameter of about 20 mm into the movement, or the size and the thickness of the movement become large. If the tip of the conductive plate spring is lubricated with oil, the resistance between the conductive plate spring and the signal input pattern on the piezobuzzer is increased so that the sound pressure of the piezobuzzer may be decreased, or the consumption current may be increased.

Moreover, in a conventional electronic timepiece, an earthing coiled spring for earthing a movement to the case back is used. In this construction, if the movement is incorporated in an exterior case having a screw type case back, due to the rotation of the case back, the earthing coiled spring may fall, causing a defect in the electrical connection. Moreover, in a structure where an earthing plate spring is provided for the electrical connection between the movement and the case back, if the longitudinal direction of the earthing plate spring is not formed in the tangential direction of the circumference and the concentric circle of the case back, if the movement is incorporated in an exterior case having a screw type case back, the earthing plate spring may be distorted, causing a defect in the electrical connection between the earthing plate spring and the case back. Furthermore, in a conventional electronic timepiece, when a movement comprising a stainless earthing plate spring for earthing the movement to the case back is fitted into an exterior case having a screw type case back, the earthing plate spring may be buckling loaded in the longitudinal direction, causing buckling. Moreover, if an earthing coiled spring or an earthing plate spring is arranged at the center of a movement, there are problems in that it becomes difficult to mount a lithium battery of a diameter of about 20 mm into the movement, or the size and the thickness of the movement become large.

Moreover, in a conventional electronic timepiece, a mode conductive plate spring which transfers a signal for setting the mode to a mode setting signal inputting pattern of a circuit block, is used. In this construction, the thinner the mode conductive plate spring, the more likely that, when mode setting, the mode conductive plate spring will be distorted, causing a defect in the electrical connection between the mode conductive plate spring and the mode setting signal inputting pattern. On the other hand, in this construction, the thicker the mode conductive plate spring, the more likely that, when mode setting, due to the mode conductive plate spring, the mode setting signal inputting pattern may be scraped away. Therefore, it has been difficult to design a mode conductive plate spring in an appropriate size.

### DISCLOSURE OF INVENTION

The construction of the present invention is such that, an electronic timepiece is constituted to notify by a piezobuzzer arranged inside of a case back of an exterior case, including: a buzzer signal transferring conductive spring for electrically connecting a signal output pattern on a circuit block and a signal input pattern on the piezobuzzer. Furthermore, the construction of the present invention is such that, an electronic timepiece being constituted to display a mode by a rotatable mode display wheel, including: a mode setting conductive spring for electrically connecting a signal input pattern on a circuit block and said mode display wheel which is constituted by a conductive material. Moreover, the construction of the present invention is such that, an electronic timepiece having an exterior case including a case back, including: an earth conductive spring for electrically connecting an electrode on one side of a power source and said case back which is formed from a conductive material. In the electronic timepiece of the present invention, the conductive spring is constituted to include one or more curved sections so as to be deformable, and the conductive spring is formed from a filler containing resin having a base resin of thermoplastic resin, and carbon filler mixed with this base resin.

In the electronic timepiece of the present invention, preferably the base resin is selected from a group consisting of: polystyrene, polyethylene terephthalate, polycarbonate, polyacetal (polyoxymethylene), polyamide, a modified polyphenylene ether, polybutylene terephthalate, polyphenylene sulfide, polyether ether ketone, and polyether imide.

Furthermore, in the electronic timepiece of the present invention, preferably the carbon filler is selected from a group consisting of: a monolayer carbon nanotube, a multilayer carbon nanotube, a vapor grown carbon fiber, a nanografiber, a carbon nanohorn, a cup stack type carbon nanotube, a monolayer fullerene, a multilayer fullerene, and a mixture of any one of the carbon fillers doped with boron.

The conductive part of the present invention is constituted so as to be provided with a conductive spring which is constituted to include one or more curved sections so as to be deformable, and a housing which retains the conductive spring. In the conductive part of the present invention, the conductive spring is formed from a filler containing resin having a base resin of thermoplastic resin, and carbon filler mixed with this base resin.

In the conductive part of the present invention, preferably the base resin is selected from a group consisting of: polystyrene, polyethylene terephthalate, polycarbonate, polyacetal (polyoxymethylene), polyamide, a modified polyphenylene ether, polybutylene terephthalate, polyphenylene sulfide, polyether ether ketone, and polyether imide.

Moreover, in the conductive part of the present invention, preferably the carbon filler is selected is selected from a group consisting of: a monolayer carbon nanotube, a multilayer carbon nanotube, a vapor grown carbon fiber, a nanografiber, a carbon nanohorn, a cup stack type carbon nanotube, monolayer fullerene, multilayer fullerene, and a mixture of any one of the carbon fillers doped with boron.

In the electronic timepiece of the present invention, the conductive spring is not buckled, the other parts are not damaged, and the conducting performance is stable. Moreover, the conductive spring of the present invention is not buckled, the other parts are not damaged, and it has a reliable conducting performance. Furthermore, in the conductive part of the present invention, the conductive spring is not buckled, the other parts are not damaged, and the conducting performance is stable.

### BRIEF DESCRIPTION OF THE DRAWINGS

FIG. 1 is a plan view showing a schematic configuration of a movement seen from the obverse side, in an embodiment of the present invention (some components are omitted in FIG. 1).

FIG. 2 is a schematic fragmentary sectional view showing a part from a second motor to a second hand, in the embodiment of the present invention.

FIG. 3 is a schematic fragmentary sectional view showing a part from a minute motor to a minute hand, in the embodiment of the present invention.

FIG. 4 is a schematic fragmentary sectional view showing a part from an hour motor to an hour hand, in the embodiment of the present invention.

FIG. 5 is a schematic fragmentary sectional view showing a part of a hand setting stem, a mode conductive spring, and a switch contact point, in the embodiment of the present invention.

FIG. 6 is a schematic fragmentary sectional view showing a conducting structure of a circuit board and a piezobuzzer, in the embodiment of the present invention.

FIG. 7 is a schematic fragmentary sectional view showing a conducting structure of a circuit board and a mode display wheel, in the embodiment of the present invention.

FIG. 8 is a plan view showing a schematic configuration of a movement seen from the back side, in the embodiment of the present invention (some components are omitted in FIG. 8).

FIG. 9 is a plan view showing a schematic configuration of a complete timepiece (an exterior case with the movement incorporated therein), in the embodiment of the present invention.

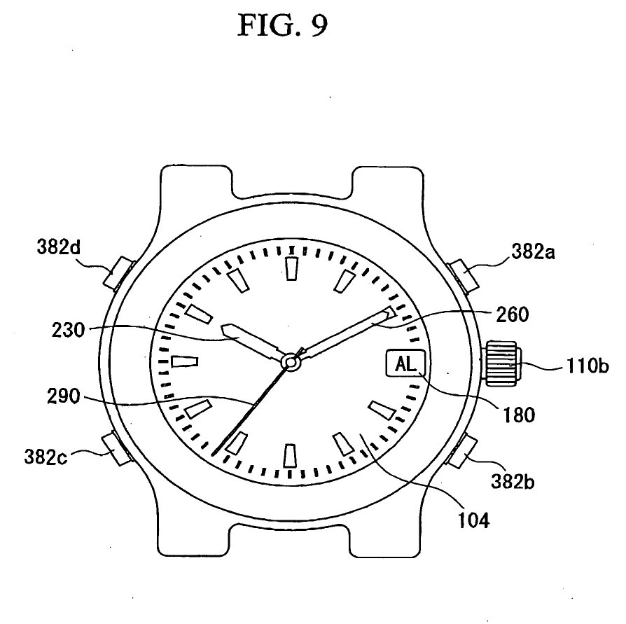

FIG. 10 is a schematic sectional view showing a structure of a conductive part in the embodiment of the present invention.

FIG. 11 is a schematic fragmentary sectional view showing a conducting structure using a coiled spring, in a conventional alarm electronic timepiece.

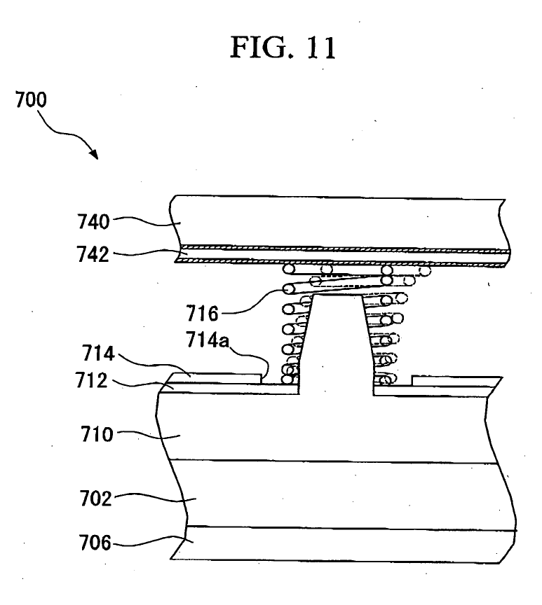

FIG. 12 is a schematic fragmentary sectional view showing a conducting structure using a plate spring, in a conventional alarm electronic timepiece.

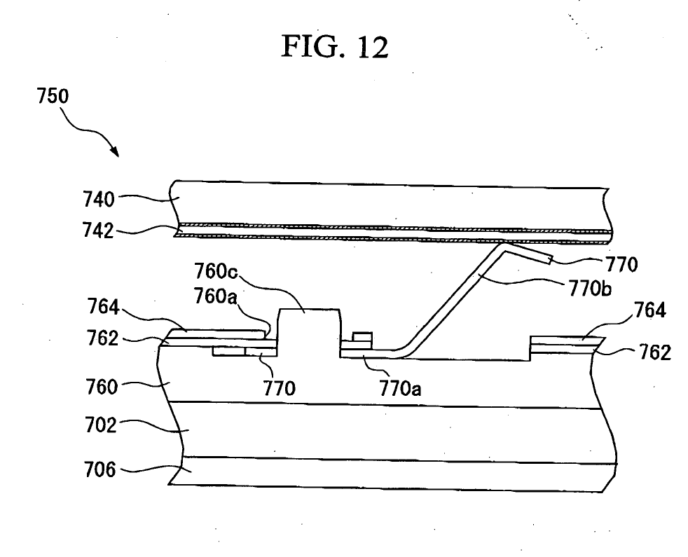

### BEST MODE FOR CARRYING OUT THE INVENTION

### (1) First Embodiment

First is a description of an electronic timepiece of an embodiment of the present invention. The embodiment of the present invention is an analog electronic timepiece.

(1-1) Structure of an Electronic Timepiece of Present Invention

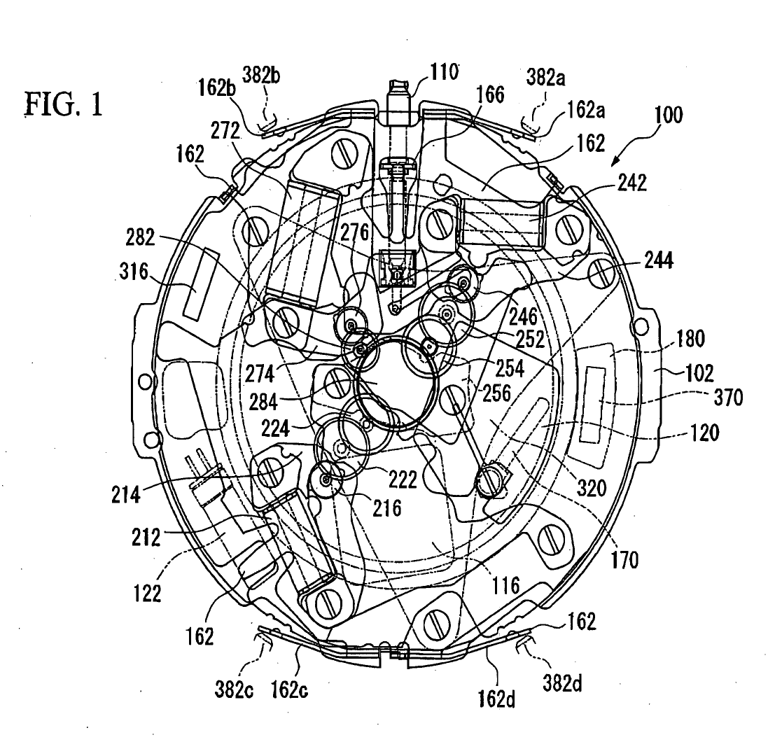

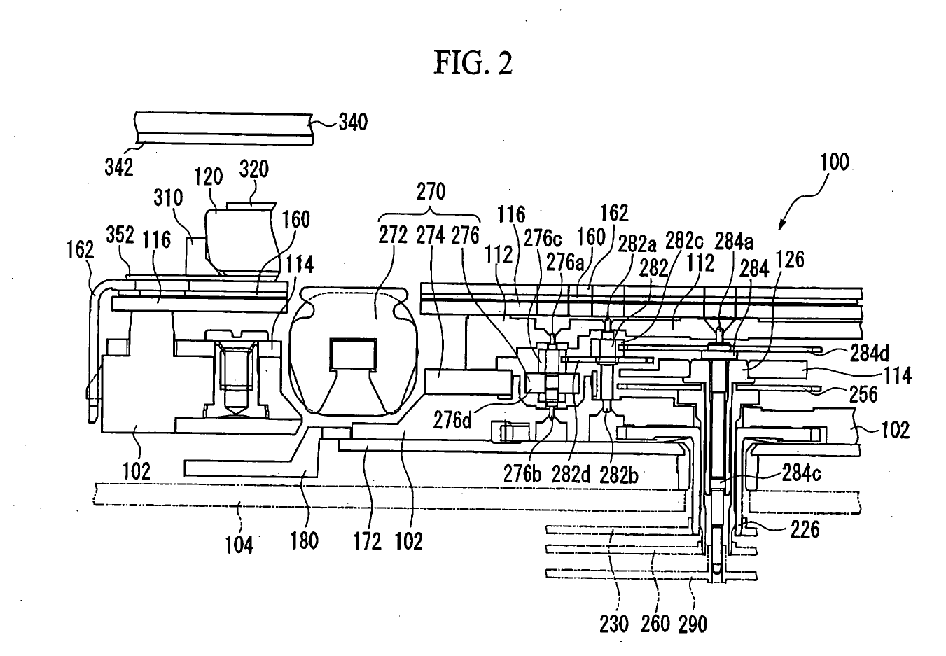

Referring to FIG. 1 to FIG. 4, in the embodiment of the present invention, a movement (machine body) 100 of the analog electronic timepiece is provided a main plate 102 constituting a substrate of the movement. A hand setting stem 110 is rotatably built into a hand setting stem guiding bole of the main plate 102. A dial 104 (denoted by imaginary lines in FIG. 2) is attached to the movement 100. The movement 100 is provided with a switching spring 166 which determines the position in the axial direction of the hand setting stem 110. On the “obverse side” of the movement 100, a battery 120, a circuit block 116, an hour motor 210, an hour display wheel train 220, a minute motor 240, a minute display wheel train 250, a second motor 270, a second display wheel train 280, and the like are arranged. The main plate 102, a wheel train bridge 112, and a second bridge 114 constitute support members.

The configuration is such that rotation of the hour motor 210 cause rotation of the hour display wheel train 220 so that an hour hand 230 can display the “hour” of the present time. Moreover, the configuration is such that rotation of the minute motor 240 cause rotation of the minute display wheel train 250 so that the minute hand 260 can display the “minute” of the present time. Furthermore, the configuration is such that rotation of the second motor 270 cause rotation of the second display wheel train 280 so that the second hand 290 can display the “second” of the present time.

An IC 118 and a quartz resonator 122 are installed in the circuit block 116. The circuit block 116 is fixed with respect to the main plate 102 and the wheel train bridge 112 by a switch spring 162 through an insulating plate 160. The switching spring 166 is integrally formed with the switch spring 162. The battery 120 constitutes the power source of the analog electronic timepiece. A rechargeable secondary battery or a rechargeable capacitor may be also used for the power source of the analog electronic timepiece. The quartz resonator 122 constitutes the oscillation source of the analog electronic timepiece. It oscillates for example at 32,768 Hertz.

Referring to FIG. 1 and FIG. 2, a second motor 270 includes a second coil block 272, a second stator 274, and a second rotor 276. When the second coil block 272 inputs a second motor drive signal, the second stator 274 is magnetized to rotate the second rotor 276. The second rotor 276 is configured for example so that it rotates 180 degrees per second. The second rotor 276 includes an upper-shaft section 276a, a lower-shaft section 276b, a pinion section 276c, and a rotor magnet 276d. The upper-shaft section 276a, the lower-shaft section 276b, and the pinion section 276c are formed from a metal such as carbon steel.

The configuration is such that, based on rotation of the second rotor 276, a second wheel 284 rotates through rotation of a second transfer wheel 282. The second transfer wheel 282 includes an upper-shaft section 282a, a lower-shaft section 282b, a pinion section 282c, and a gear wheel section 282. The pinion section 276c is configured so that it meshes with the gear wheel section 282d. The upper-shaft section 282a, the lower-shaft section 282b, and the pinion section 282c are formed from a metal such as carbon steel. The gear wheel section 282d is formed from a metal such as brass. The second wheel 284 is configured for example so that it rotates once per minute. The second wheel 284 includes an upper-shaft 284a, a bead section 284b, and a gear wheel section 284d. The pinion section 282c is configured so that it meshes with the gear wheel section 284d. The upper-shaft section 284a and the bead section 284b are formed from a metal such as carbon steel. The gear wheel sections 284d is formed from a metal such as brass.

The second hand 290 is attached to the second wheel 284. The second hand 290 constitutes a second display member. The second display wheel train 220 includes the second transfer wheel 282 and the second wheel 284. The second rotor 276 and the second transfer wheel 282 are rotatably supported with respect to the main plate 102 and the wheel train bridge 112. The second wheel 284 is rotatably supported with respect a center pipe 126 provided on the second bridge 114 and the wheel train bridge 112. That is, the upper-shaft section 276a of the second rotor 276, the upper-shaft section 282a of the second transfer wheel 282, and the upper-shaft section 284a of the second wheel 284 are rotatably supported with respect to the wheel train bridge 112. Moreover, the lower-shaft section 276b of the second rotor 276 and the lower-shaft section 282b of the second transfer wheel 282 are rotatably supported with respect to the main plate 102. A bearing of the wheel train bridge 112 which rotatably supports the upper-shaft section 276a of the second rotor 276, a bearing of the wheel train bridge 112 which rotatably supports the upper-shaft section 282a of the second transfer wheel 282, and a bearing of the wheel train bridge 112 which rotatably supports the upper-shaft section 284a of the second wheel 284, are lubricated with lubricating oil. A bearing of the main plate 102 which rotatably supports the lower-shaft section 276b of the second rotor 276, and a bearing of the main plate 102 which rotatably supports the lower-shaft section 282b of the second transfer wheel 282, are lubricated with lubricating oil. For this lubricating oil, it is preferable to use precision instrument oil, and it is particularly preferable to use so-called chronometer oil. Examples of such chronometer oil include “Moebius Synt-A-Lube 9010 (trademark)” available from MOEBIUS Co, Ltd.

In order to increase the retention capacity of the lubricating oil, it is preferable to provide the respective bearings of the wheel train bridge 112 and the respective bearings of the main plate 102, with sump sections of cone, cylindrical, or truncated cone shape. If the sump section is provided, the lubricating oil can be effectively prevented from spreading by the surface tension of the oil. The main plate 102 and the wheel train bridge 112 are formed from a metal such as brass.

Referring to FIG. 1 to FIG. 4, a battery negative terminal 170 is attached in the main plate 102. The battery negative terminal 170 electrically connects a negative electrode of the battery 120 and a negative input section Vss of an IC 118, through the negative pattern of the circuit block 116. A battery clamp 320 is incorporated in a switch spring 162. An insulating plate 352 for insulating the negative electrode of the battery 120 from the switch spring 162 is arranged between the battery 120 and the battery clamp 320. The insulating plate 352 is formed from a plastic sheet such as polyimide. A battery frame 310 for locating the battery 120 is fixed with respect to the main plate 102. The battery frame 310 is formed from a plastic such as polycarbonate. The battery 120 is fixed with respect to the main plate 102 by the battery clamp 320. The battery clamp 320 and the switch spring 162 electrically connect a positive electrode of the battery 120 and a positive electrode inputting section Vss of an IC 118, via a positive electrode pattern on the circuit block 116. The main plate 102 is electrically connected to the positive electrode of the battery 120 via the battery clamp 320 and/or the switch spring 162.

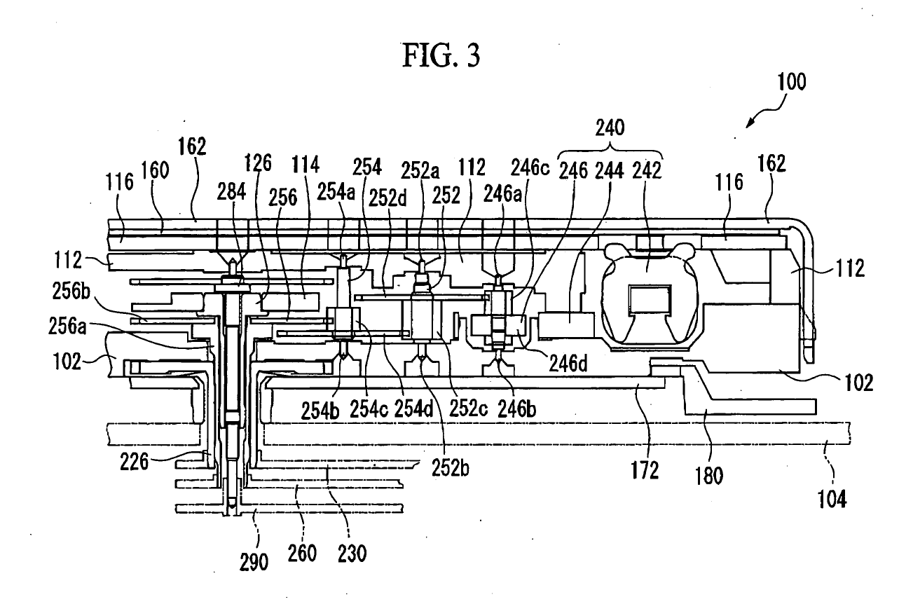

Referring to FIG. 1 and FIG. 3, a minute motor 240 includes a minute coil block 242, a minute stator 244, and a minute rotor 246. When the minute coil block 242 inputs a minute motor drive signal, the minute stator 244 is magnetized to rotate the minute rotor 246. The minute rotor 246 is configured for example so that it rotates 180 degrees per 20 seconds. The minute rotor 246 includes an upper-shaft section 246a, a lower-shaft section 246b, a pinion section 246c, and a rotor magnet 246d. The upper-shaft section 246a, the lower-shaft section 246b, and the pinion section 246c are formed from a metal such as carbon steel.

The configuration is such that, based on rotation of the minute rotor 246 a first minute transfer wheel 252 rotates, and based on rotation of the first minute transfer wheel 252 a minute wheel 256 rotates through rotation of a second minute transfer wheel 254. The first minute transfer wheel 252 includes an upper-shaft section 252a, a lower-shaft section 252b, a pinion section 252c, and a gear wheel section 252d. The pinion section 246c is configured so that it meshes with the gear wheel section 252d. The upper-shaft section 252a, the lower-shaft section 252b, and the pinion section 252c are formed from a metal such as carbon steel. The gear wheel section 252d is formed from a metal such as brass. The second minute transfer wheel 254 includes an upper-shaft section 254a, a lower-shaft section 254b, a pinion section 254c, and a gear wheel section 254d. The pinion section 254c is configured so that it meshes with the gear wheel section 254d. The upper-shaft section 254a, the lower-shaft section 254b, and the pinion section 254c are formed from a metal such as carbon steel. The gear wheel section 254d is formed from a metal such as brass. The minute wheel 256 includes a cylindrical section 256a and a gear wheel section 256d. The pinion section 254c is configured so that it meshes with the gear wheel section 256d. The cylindrical section 256a is formed from a metal such as carbon steel. The gear wheel sections 256d is formed from a metal such as brass.

The minute wheel 256 is configured so that it rotates once per hour. The minute hand 260 is attached to the minute wheel 256. The center of rotation of the minute wheel 256 is the same as the center of rotation of the second wheel 284. The minute hand 260 constitutes a minute display member. The minute display wheel train 250 includes the first minute transfer wheel 252, the second minute transfer wheel 254, and the minute wheel 256. The minute rotor 246, the first minute transfer wheel 252, and the second minute transfer wheel 254 are rotatably supported with respect to the main plate 102 and the wheel train bridge 112. The minute wheel 256 is rotatably supported and contacts with a periphery of a center pipe 126 provided on the second bridge 114. That is, the upper-shaft section 246a of the minute rotor 246, the upper-shaft section 252a of the first minute transfer wheel 252, and the upper-shaft section 254a of the second minute transfer wheel 254 are rotatably supported with respect to the wheel train bridge 112. Moreover, the lower-shaft section 246b of the minute rotor 246, the lower-shaft section 252b of the first minute transfer wheel 252, and the lower-shaft section 254b of the second minute transfer wheel 254 are rotatably supported with respect to the main plate 102.

A bearing of the wheel train bridge 112 which rotatably supports the upper-shaft section 246a of the minute rotor 246, a bearing of the wheel train bridge 112 which rotatably supports the upper-shaft section 252a of the first minute transfer wheel 252, and a bearing of the wheel train bridge 112 which rotatably supports the upper-shaft section 254a of the second minute transfer wheel 254, are lubricated with lubricating oil. A bearing of the lower-shaft section 246b of the minute rotor 246, a bearing of the main plate 102 which rotatably supports the lower-shaft section 252b of the first minute transfer wheel 252, and a bearing of the main plate 102 which rotatably supports the lower-shaft section 254b of the second minute transfer wheel 254, are lubricated with lubricating oil. For this lubricating oil, it is preferable to use precision instrument oil, and it is particularly preferable to use so-called chronometer oil. In order to increase the retention capacity of the lubricating oil, it is preferable to provide the respective bearings of the wheel train bridge 112 and the respective bearings of the main plate 102, with sump sections of cone, cylindrical, or truncated cone shape.

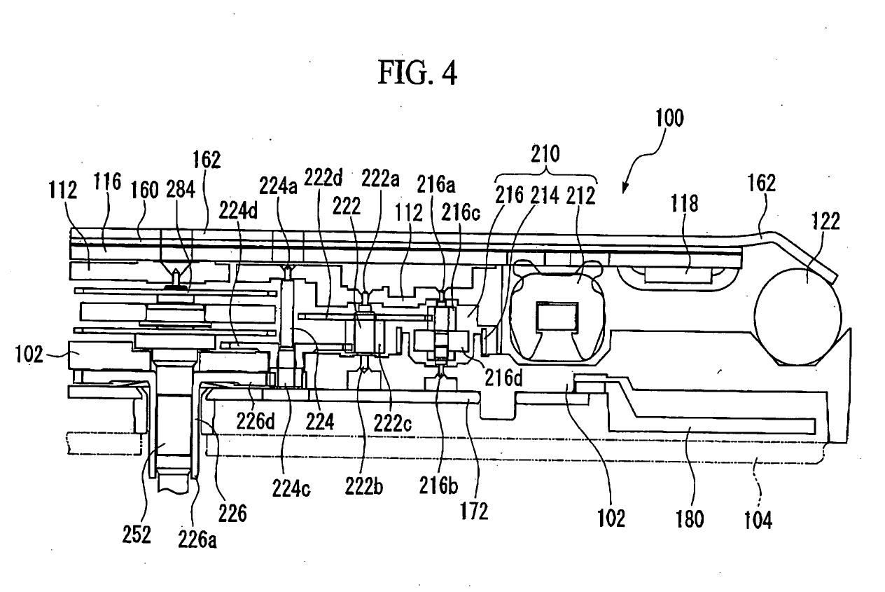

Referring to FIG. 1 and FIG. 4, an hour motor 210 includes an hour coil block 212, an hour stator 214, and an hour rotor 216. When the hour coil block 212 inputs an hour motor drive signal, the hour stator 214 is magnetized to rotate the hour rotor 216. The hour rotor 216 is configured for example so that it rotates 180 degrees per 20 minutes. The hour rotor 216 includes an upper-shaft section 216a, a lower-shaft section 216b, a pinion section 216c, and a rotor magnet 216d. The upper-shaft section 216a, the lower-shaft section 216b, and the pinion section 216c are formed from a metal such as brass.

The configuration is such that, based on rotation of the hour rotor 216 a first hour transfer wheel 222 rotates, and based on rotation of the first hour transfer wheel 222 an hour wheel 226 rotates through rotation of a second hour transfer wheel 224. The first hour transfer wheel 222 includes an upper-shaft section 222a, a lower-shaft section 222b, a pinion section 222c, and a gear wheel section 222d. The pinion section 216c is configured so that it meshes with the gear wheel section 222d The upper-shaft section 222a, the lower-shaft section 222b, and the pinion section 222c are formed from a metal such as carbon steel. The gear wheel section 222d is formed from a metal such as brass. The second hour transfer wheel 224 includes an upper-shaft section 224a, a lower-shaft section 224b, a pinion section 224c, and a gear wheel section 224d. The pinion section 222c is configured so that it meshes with the gear wheel section 224d. The upper-shaft section 224a, the lower-shaft section 224b, and the pinion section 224c are formed from a metal such as carbon steel. The gear wheel section 224d is formed from a metal such as brass. The hour wheel 226 includes a cylindrical section 226a and a gear wheel section 226d. The pinion section 224c is configured so that it meshes with the gear wheel section 226d. The hour wheel 226 is formed from a metal such as brass.

The hour wheel 226 is configured so that it rotates once per 12 hours. The hour hand 230 is attached to the hour wheel 226. The center of rotation of the hour wheel 226 is the same as the center of rotation of the minute wheel 256. Therefore, the center of rotation of the hour wheel 226, the center of rotation of the minute wheel 256, and the center of rotation of the second wheel 284 are the same. The hour hand 230 constitutes an hour display member. The hour display wheel train 220 includes the first hour transfer wheel 222, the second hour transfer wheel 224, and the hour wheel 226. The hour rotor 216, the first hour transfer wheel 222, and the second hour transfer wheel 224 are rotatably supported with respect to the main plate 102 and the wheel train bridge 112. The hour wheel 226 is rotatably supported and contacts with a periphery of the minute wheel 256. That is, the upper-shaft section 216a of the hour rotor 216, the upper-shaft section 222a of the first hour transfer wheel 222, and the upper-shaft section 224a of the second hour transfer wheel 224 are rotatably supported with respect to the wheel train bridge 112. Moreover, the lower-shaft section 216b of the hour rotor 216, the lower-shaft section 222b of the first hour transfer wheel 222, and the lower-shaft section 224b of the second hour transfer wheel 224 are rotatably supported with respect to the main plate 102.

A bearing of the wheel train bridge 112 which rotatably supports the upper-shaft section 216a of the hour rotor 216, a bearing of the wheel train bridge 112 which rotatably supports the upper-shaft section 222a of the first hour transfer wheel 222, and a bearing of the wheel train bridge 112 which rotatably supports the upper-shaft section 224a of the second hour transfer wheel 224, are lubricated with lubricating oil. A bearing of the lower-shaft section 216b of the hour rotor 216, a bearing of the main plate 102 which rotatably supports the lower-shaft section 222b of the first hour transfer wheel 222, and a bearing of the main plate 102 which rotatably supports the lower-shaft section 224b of the second hour transfer wheel 224, are lubricated with lubricating oil. For this lubricating oil, it is preferable to use precision instrument oil, and it is particularly preferable to use a so-called chronometer oil. In order to increase the retention capacity of the lubricating oil, it is preferable to provide the respective bearings of the wheel train bridge 112 and the respective bearings of the main plate 102, with sump sections of cone, cylindrical, or truncated cone shape.

A mode display wheel 180 is rotatably constituted with respect to the main plate 102. The mode display wheel 180 is formed from a conductive material such as brass. The mode display wheel 180 is electrically connected to a positive electrode of the battery 120 via a battery clamp 320 and/or a switch spring 162.

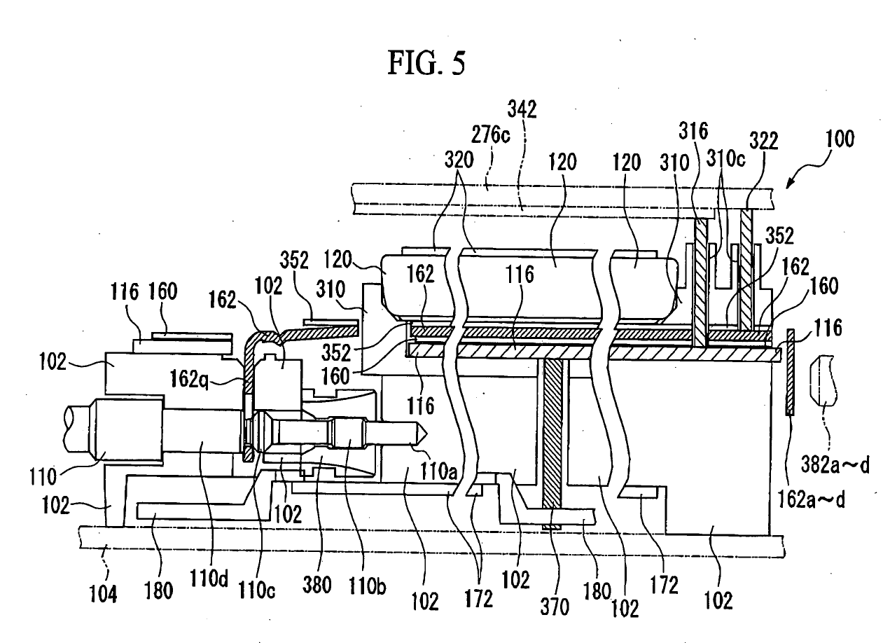

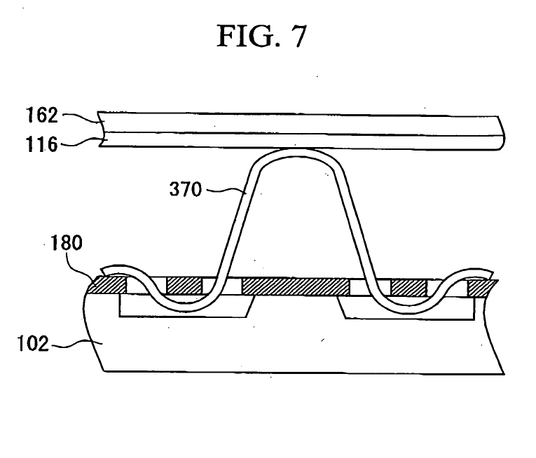

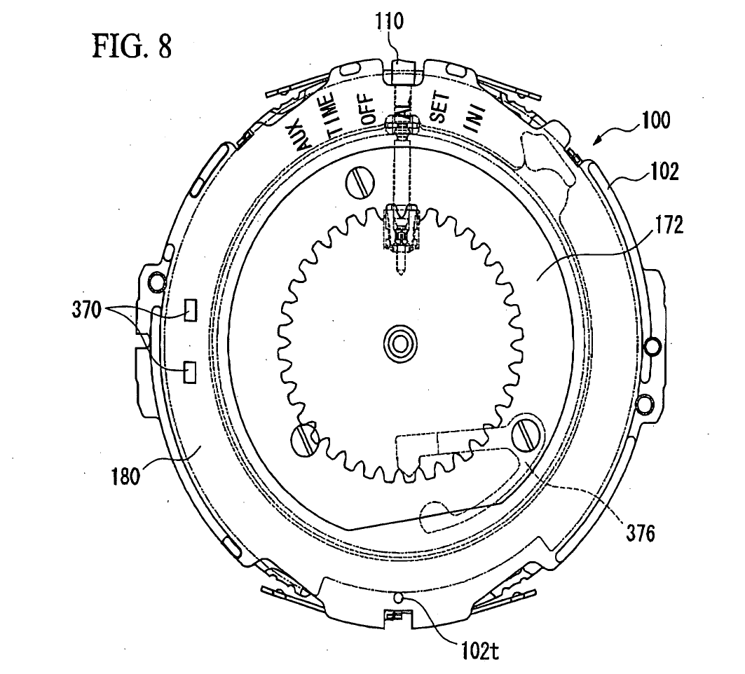

Referring to FIG. 5, FIG. 7 and FIG. 8, the construction is such that, when the hand setting stem 110 is arranged on a first step, the mode display wheel 180 can be rotated by rotating the hand setting stem 110. The position of the mode display wheel 180 is located by a locating jumper spring 376. On the surface on the side having a dial 104 of the mode display wheel 180, characters denoting modes such as “AL”, “OFF”, “SET”, “TIME”, “INI”, “AUX” and the like are provided. The construction is such that, when the hand setting stem 110 is arranged on the first step, by rotating the hand setting stem 110, the mode display wheel 180 is rotated so that a character denoting a mode can be seen from a window arranged on the dial 104. “AL” denotes a mode to buzz an alarm. “OFF” denotes a mode not to buzz the alarm. “SET” denotes a mode to set a time to buzz an alarm. “TIME” denotes a mode to display a present time. “INI” denotes a mode to initialize the contents of an IC counter. “AUX” denotes a mode of other additional functions, for example, chronograph and the like.

A rotation restricting section 102t (for example, rotation restricting pin) for restricting the rotation of the mode display wheel 180 is provided on the main plate 102. The construction is such that, a locating section provided on the circumference of the mode display wheel 180 is contacted with the rotation restricting section 102t so as to restrict the rotation of the mode display wheel 180.

The hand setting stem 110 includes a tip shaft section 110a, a correcting wheel mating part 110b, a bead section 110c, and a guiding shaft 110d. The tip shaft section 110a and the guiding shaft 110d are rotatably built in with respect to the main plate 102. A hand setting stem locating section 162g of a switch spring 162 is arranged so that it contacts with the bead section 110c. A correcting wheel 380 is arranged so that a teeth section meshes with the teeth section of the mode display wheel 180. The construction is such that, when the hand setting stem 110 is arranged on a first step, the correcting wheel mating part 110b of the hand setting stem 110 fits to a central hole of the correcting wheel 380 and the hand setting stem 110 is rotated so as to integrally rotate the correcting wheel 380. By rotating the correcting wheel 380, the mode display wheel 180 can be rotated. The construction is such that, when the hand setting stem 110 is arranged on a zero step, the correcting wheel mating part 110b of the hand setting stem 110 does not fit to the central hole of the correcting wheel 380, even if the hand setting stem 110 is rotated, so as not to rotate the correcting wheel 380.

The correcting wheel 380 is preferably formed from a plastic such as polycarbonate. The construction is such that, when the hand setting stem 110 is arranged on a first step and the hand setting stem 110 is rotated, so that the mode display wheel 180 is rotated by the rotation of the correcting wheel 380, and a locating section provided on the circumference of the mode display wheel 180 is contacted with the rotation restricting section 102t, the central hole of the correcting wheel 380 and the correcting wheel mating part 110 of the hand setting stem 110 slip. Therefore, when the hand setting stem 110 is arranged on the first step and the locating section provided on the circumference of the mode display wheel 180 is contacted with the rotation restricting section 102t, even if the hand setting stern 110 is further rotated, the correcting wheel 380, the mode display wheel 180 and the hand setting stem 110 will not damaged.

On the switch spring 162, four switch terminal sections 162a to 162d are provided. Push buttons 382a to 382d are provided so as to correspond to the four switch terminal sections 162a to 162d. The construction is such that, by pressing the push buttons 382a to 382d, the switch terminal sections 162a to 162d are electrically connected to the switch pattern on the circuit block 116 so as to perform predetermined operations. As described above, the battery clamp 320 and the switch spring 162 are electrically connected to the positive electrode of the battery 120. Therefore, the construction is such that, when the switch terminal sections 162a to 162d are electrically connected to the switch pattern on the circuit block 116, the switch pattern on the circuit block 116 is electrically connected to the positive electrode of the battery 120. The switch terminal section 162a and the push button 382a are arranged approximately on the two o'clock side of the movement. The switch terminal section 162b and the push button 382b are arranged approximately on the four o'clock side of the movement. The switch terminal section 162c and the push button 382c are arranged approximately on the eight o'clock side of the movement. The switch terminal section 162d and the push button 382d are arranged approximately on the ten o'clock side of the movement.

The configuration is such that, based on the oscillation of a quartz resonator 212, a frequency dividing circuit divides an output signal from an oscillation circuit. The configuration is such that, based on the output signal from the frequency dividing circuit, an hour motor driving circuit outputs a motor drive signal which drives the hour motor 210, to the hour motor 210. The configuration is such that, based on the output signal from the frequency dividing circuit, a minute motor driving circuit outputs a motor drive signal which drives the minute motor 240, to the minute motor 240. The configuration is such that, based on the output signal from the frequency dividing circuit, a second motor driving circuit outputs a motor drive signal which drives the second motor 270, to the second motor 270. In a normal time display mode, the configuration is such that the hour motor driving circuit outputs a motor drive signal which drives the hour motor 210, to the hour motor 210, the minute motor driving circuit outputs a motor drive signal which drives the minute motor 240, to the minute motor 240, and the second motor driving circuit outputs a motor drive signal which drives the second motor 270, to the second motor 270, in order to display a time to buzz an alarm by the hour hand 230, the minute hand 260, and the second hand 290. An alarm time calculating circuit is configured to calculate the time to buzz the alarm, based on an output signal from the frequency dividing circuit.

In the alarm time setting mode, the constitution is such that, when a push button is pressed, the hour motor driving circuit outputs a motor drive signal which drives the hour motor 210, to the hour motor 210, and the minute motor driving circuit outputs a motor drive signal which drives the minute motor 240, to the minute motor 240, in order to display a time to buzz an alarm by the hour hand 230 and the minute hand 260. In the alarm time setting mode, the constitution is such that, when the time has come to buzz the alarm, the piezobuzzer driving circuit outputs a piezobuzzer drive signal which makes a piezobuzzer 342 perform based on the output signal from the alarm time calculating circuit, to the piezobuzzer 342.

The oscillation circuit, the frequency dividing circuit, the hour motor driving circuit, the minute motor driving circuit, the second motor driving circuit, the alarm time calculating circuit, and the piezobuzzer driving circuit are incorporated in an IC 118. The IC 118 may be a PLA-IC having a built-in program to perform various types of operations. In the embodiment of the electronic timepiece of the present invention, external elements such as a resistor, a capacitor, a coil, a diode, a transistor may be used in addition to the IC 118 as necessary.

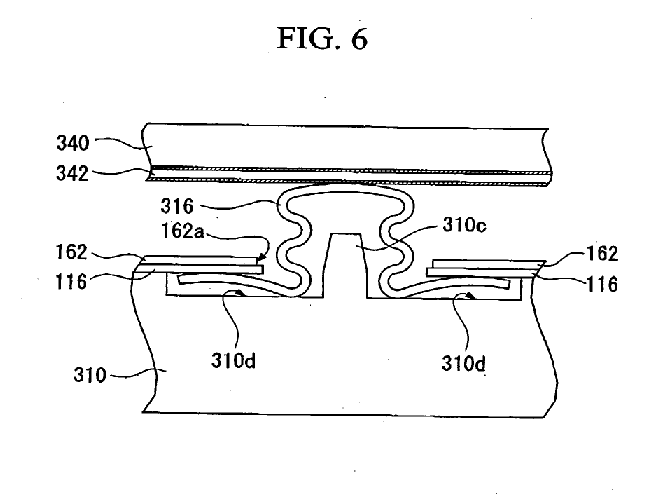

Referring to FIG. 6, a signal output pattern for outputting a piezobuzzer drive signal is provided on the surface of the circuit block 116. A signal input pattern for inputting a piezobuzzer drive signal is provided on a piezobuzzer 342 arranged inside of a case back 340. A buzzer conductive spring 316 for electrically connecting the signal output pattern on the circuit block 116 and the signal input pattern for inputting the piezobuzzer drive signal on the piezobuzzer 342, is provided in the movement 100. The buzzer conductive spring 316 is preferably constituted to include one or more curved sections so as to be deformable. The buzzer conductive spring 316 is preferably formed into a “v” shape, a “U” shape, an “Ω”shape, or the like. Or, the buzzer conductive spring 316 is preferably formed into a “v” shape having bend sections on both ends, a “U” shape having bend sections on both ends, an “Ω”shape having both ends opened, or the like. The buzzer conductive spring 316 preferably has a waveform shape including a convex curved section being convex outwards and a concave curved section being concave outwards. The buzzer conductive spring 316 is formed from a conductive material.

The constitution is such that at least one end of the buzzer conductive spring 316, or at least a curved section close to one end, contacts with the signal output pattern. The constitution is such that a convex curved section being convex outwards in the middle of the buzzer conductive spring 316 contacts with the signal input pattern. On the part where the buzzer conductive spring 316 and the signal output pattern contact, a switch spring 162 is preferably arranged. A window section 162a for clearance from the buzzer conductive spring 316 is provided in the switch spring 162. Due to this constitution, deflection of the circuit block 116 can be prevented so as to ensure the contact force of the buzzer conductive spring 316 and the signal output pattern. To the switch spring 162 on the part where the buzzer conductive spring 316 and the signal output pattern contact, a presser spring section for adding to the elastic force toward the buzzer conductive spring 316 may be provided. As a modified example, the configuration may be such that the end section of the buzzer conductive spring 316 is soldered to the signal output pattern.

A guiding section 310c for guiding the buzzer conductive spring 316 is provided in the battery frame 310. A recessed section 310d for clearance from both ends of the buzzer conductive spring 316 is provided in the battery frame 310. The guiding section 310c may be cylindrical, conical, truncated conical, or quadratic prism. The buzzer conductive spring 316 can be reliably located by providing the guiding section 310c. The buzzer conductive spring 316 is formed from a filler containing resin having a base resin of thermoplastic resin, and carbon filler mixed with this base resin. This filler containing resin is a conductive material. Therefore, by forming the buzzer conductive spring 316 from a filler containing resin, the conductivity performance required for the buzzer conductive spring 316 can be ensured.

An earthing spring 322 for earthing the movement 100 to the case back is provided in the movement 100. The earthing spring 322 is preferably constituted to include one or more curved sections so as to be deformable. The shape of the earthing spring 322 is preferably similar to the shape of the buzzer conductive spring 316 described above. The earthing spring 322 is formed from a conductive material. The earthing spring 322 is constituted so as to contact with the battery clamp 320. Therefore, the earthing spring 322 is electrically connected to the positive electrode of the battery 120. A guiding section 310f for guiding the earthing spring 322 is provided in the battery frame 310. The guiding section 310d is preferably formed in a slender window shape. The earthing spring 322 can be reliably located by providing the guiding section 310d. As a modified example, the configuration may be such that the end section of the earthing spring 322 is soldered to any one of the battery clamp 320, the switch spring 162, or the positive electrode pattern of the circuit block 116. The earthing spring 322 is formed from a filler containing resin having a base resin of thermoplastic resin, and carbon filler mixed with this base resin. The filler containing resin is a conductive material. Therefore, by forming the earthing spring 322 from a filler containing resin, the conductivity performance required for the earthing spring 322 can be ensured.

The base resin used in the present invention is generally polystyrene, polyethylene terephthalate, polycarbonate, polyacetal (polyoxymethylene), polyamide, modified polyphenylene ether, polybutylene terephthalate, polyphenylene sulfide, polyether ether ketone, or polyether imide. That is, in the present invention, the base resin is preferably made of a so-called general-purpose engineering plastic or a so-called super engineering plastic. In the present invention, a general-purpose engineering plastic or a super engineering plastic other than the above can also be used for the base resin. It is preferable that the base resin used for the present invention is a thermoplastic resin. The carbon filler used in the present invention is generally; a monolayer carbon nanotube, a multilayer carbon nanotube, a vapor grown carbon fiber, a nanografiber, a carbon nanohorn, a cup stack type carbon nanotube, a monolayer fullerene, a multilayer fullerene, or a mixture of any one of the aforementioned carbon fillers doped with boron. Preferably the carbon filler is contained as 0.2 to 60% by weight of the total weight of the filler containing resin. Or preferably the carbon filler is contained as 0.1 to 30% by volume of the total volume of the filler containing resin.

Preferably the monolayer carbon nanotube has a diameter of 0.4 to 2 μm, and an aspect ratio (length/diameter) of 10 to 1000, specifically an aspect ratio of 50 to 100. The monolayer carbon nanotube is formed in a hexagon shaped netlike having a cylindrical shape or a truncated-cone shape, and is a monolayer structure. The monolayer carbon nanotube can be obtained from Carbon Nanotechnologies Inc. (CNI) in the U.S.A. as “SWNT”.

Preferably the multilayer carbon nanotube has a diameter of 2 to 100 nm, and an aspect ratio of 10 to 1000, specifically an aspect ratio of 50 to 100. The multilayer carbon nanotube is formed in a hexagon shaped netlike having a cylindrical shape or a truncated-cone shape, and is a multilayer structure. The multilayer carbon nanotube can be obtained from NIKKISO as “MWNT”.

Such carbon nanotubes are described in “Carbon Nanotubes and Accelerated Electronic Applications” (“Nikkei Science” March, 2001 issue, pp 52-62) and “The Challenge of Nano Materials” (“Nikkei Mechanical” December, 2001 issue, pp 36-57) by P. G. Collins et. al., or the like. Moreover, the configuration and the manufacturing method of carbon fiber-containing resin composition has been disclosed for example in Japanese Unexamined Patent Application, First Publication No. 2001200096.

Preferably the vapor grown carbon fiber has a diameter of 50 to 200 nm, and an aspect ratio of 10 to 1000, specifically an aspect ratio of 50 to 100. The vapor grown carbon fiber is formed in a hexagon shaped netlike having a cylindrical shape or a truncated-cone shape, and is a multilayer structure. The vapor grown carbon fiber can be obtained from SHOWA DENKO as “VGCF (trademark)”. The vapor grown carbon fiber has been disclosed for example in Japanese Unexamined Patent Application, First Publication No. H05-321039, Japanese Unexamined Patent Application, First Publication No. H07-150419, and Japanese Examined Patent Application, Second Publication No. H03-61768.

Preferably the nanografiber has an outer diameter of 2 to 500 nm, and an aspect ratio of 10 to 1000, an aspect ratio of 50 to 100 being particularly preferable. The nanografiber has an almost solid cylindrical shape. The nanografiber can obtained from ISE ELECTRON/now changed to NORITAKE ITRON CORP.

Preferably the carbon nanohorn has a diameter of 2 to 500 nm, and an aspect ratio of 10 to 1000, an aspect ratio of 50 to 100 being particularly preferable. The carbon nanohorn has a cup shape being a hexagon shaped netlike.

Preferably the cup stack type carbon nanotube has a shape where the carbon nanohorn is laminated into a cup shape, and an aspect ratio of 10 to 1000, an aspect ratio of 50 to 100 being particularly preferable.

Fullerene is a molecule which uses a carbon cluster as a parent. The definition of CAS, is that it is a molecule being a closed globular shape with 20 or more carbon atoms respectively combined with adjacent three atoms. Monolayer fullerene has a football like shape. Preferably the monolayer fullerene has a diameter of 0.1 to 500 nm. Preferably the composition of the monolayer fullerene is C60 to C540, the monolayer fullerene is for example C60, C70, and C120. The diameter of C60 is about 0.7 nm. Multilayer fullerene has a telescopic shape with the monolayer fullerene mentioned above concentrically laminated. Preferably the multilayer fullerene has a diameter of 0.1 nm to 1000 nm, a diameter of 1 nm to 500 nm being particularly preferable. Preferably the multilayer fullerene has a composition of C60 to C540. Preferably the multilayer fullerene has a configuration with for example C70 arranged on the outside of C60, and C120 arranged further on the outside of C70. Such multilayer fullerene has been described for example in “The Abundant Generation of Onion Structured Fullerene and Application to Lubricants” (“Japan Society for Precision Engineering” vol.67, No.7, 2001) by Takahiro Kakiuchi et. al.

Furthermore, the aforementioned carbon filler may also be made with any of the carbon fillers (a monolayer carbon nanotube, a multilayer carbon nanotube, a vapor grown carbon fiber, a nanografiber, a carbon nanohorn, a cup stack mold carbon nanotube, a monolayer fullerene, or a multilayer fullerene) doped with boron. The method of doping the carbon filler with boron is disclosed in Japanese Unexamined Patent Application, First Publication No. 2001-200096 or the like. In the method disclosed in Japanese Unexamined Patent Application, First Publication No. 2001-200096, the carbon fiber and boron manufactured by the gaseous-phase method, are mixed by means of a Henschel mixer type mixer, and this mixture is heat-treated at about 2300° C. in a high-frequency induction furnace or the like. Then, the heat-treated mixture is ground by a grinder. Next, the base resin and the ground mixture are blended at a predetermined rate, and melting and kneading carried out by an extruder in order to manufacture a pellet.

Referring to FIG. 7, a mode signal input pattern for inputting a mode signal onto the back face of the circuit block 116 is provided. A mode conductive spring 370 for electrically connecting the signal input pattern on the circuit block 116 and the mode display wheel 180 is provided in the movement 100. The mode conductive spring 370 is preferably constituted to include one or more curved sections so as to be deformable. The mode conductive spring 370 is preferably formed into a “v” shape, a “U” shape, an “Ω”shape, or the like. Or, the mode conductive spring 370 is preferably formed into a “v” shape having bend sections on both ends, a “U” shape having bend sections on both ends, an “Ω”shape having both ends opened, or the like. The mode conductive spring 370 preferably has a waveform shape including a convex curved section being convex outwards and a concave curved section being concave outwards. The mode conductive spring 370 is formed from a conductive material.

Both ends of the mode conductive spring 370 are fixed to the mode display wheel 180. The constitution is such that a convex curved section being convex outwards in the middle of the mode conductive spring 370 contacts with the mode signal input pattern. On the part where the mode conductive spring 370 and the mode signal output pattern contact, a switch spring 162 is preferably arranged. Due to this constitution, deflection of the circuit block 116 can be prevented so as to ensure the contact force of the mode conductive spring 370 and the mode signal output pattern. In the circuit block 116, “AL pattern” which receives a signal for setting a mode to buzz the alarm, “OFF pattern” which receives a signal for setting a mode not to buzz the alarm, “SET pattern” which receives a signal for setting a mode to set a time to buzz an alarm, “TIME pattern” which receives a signal for setting a mode to display a present time, “INI pattern” which receives a signal for setting a mode to initialize the contents of an IC counter, “AUX pattern” which receives a signal for setting a mode of other additional functions, for example, chronograph and the like, are provided.

The mode conductive spring 370 is formed from a filler containing resin having a base resin of thermoplastic resin, and carbon filler mixed with this base resin. This filler containing resin is a conductive material. Therefore, by forming the mode conductive spring 370 from a filler containing resin, the conductivity performance required for the mode conductive spring 370 can be ensured. The specification of this base resin and the carbon filler is similar to the buzzer conductive spring 316 described above. Since the mode conductive spring 370 is constituted to include one or more curved sections so as to be deformable, the mode conductive spring 370 is not distorted when mode setting. Moreover, since the mode conductive spring 370 is formed from a filler containing resin, the pattern for inputting a mode signal of the circuit block 116 is not scraped away by the mode conductive spring 370. Due to the above constitution, the mode conductive spring 370 is electrically connected to the positive electrode of the battery 120 through the mode display wheel 180, the main plate 102, the battery clamp 320 and/or the switch spring 162. The pattern for inputting a mode signal of the circuit block 116 is not electrically connected to the positive electrode of the battery 120 at normal times. The constitution is such that, if the mode conductive spring 370 contacts with the mode signal input pattern of the circuit block 116 so that the mode signal input pattern is electrically connected to the positive electrode of the battery 120, then a signal for setting the mode is input to the IC 118.

(1.2) Operation of Electronic Timepiece of the Present Invention

Next is a description of an operation of the electronic timepiece of the present invention. Referring to FIG. 1 and FIG. 5 to FIG. 8, a crown 110b is incorporated in the hand setting stem 110. When the crown 110b is drawn out and the hand setting stem 110 is arranged at the first step, by rotating the hand setting stem 110, the mode display wheel 180 can be rotated. The mode display wheel 180 is rotated so that “INT” is displayed in the window section of the dial. In this condition, a convex curved section being convex outwards in the middle of the mode conductive spring 370 contacts with the “INT pattern” of the circuit block 116. Next, by pressing a push button 382d for 3 seconds or more, the contents of the IC counter is set to a condition enabling initializing. Next, by pressing the push button 382a, the hour motor 210 is driven to adjust the hour hand 230 to the position of 12 o'clock. Next, by pressing the push button 382b, the minute motor 240 is driven to adjust the minute hand 260 to the position of 12 o'clock. Next, by pressing the push button 382c, the second motor 270 is driven to adjust the second hand 290 to the position of 12 o'clock. Next, by pressing the push button 382d for 3 seconds or more, initialization of the contents of the IC counter is finished. In this condition, even if the hand setting stem 110 is moved to the zero step, no operation is performed.

When the hand setting stem 110 is arranged at the first step, by rotating the hand setting stem 110, the mode display wheel 180 can be rotated. The mode display wheel 180 is rotated so that “TIME” is displayed in the window section of the dial. In this condition, the convex curved section being convex outwards in the middle of the mode conductive spring 370 contacts with the “TIME pattern” of the circuit block 116. Next, by pressing the push button 382d for 3 seconds or more, the contents of the IC counter is set to a condition enabling display of the present time. Next, by pressing the push button 382a, the hour motor 210 is driven to adjust the hour hand 230 to the position of “hour” of the present time. Next, by pressing the push button 382b, the minute motor 240 is driven to adjust the minute hand 260 to the position of “minute” of the present time.

Next, by pressing the push button 382c, the second motor 270 is driven to adjust the second hand 290 to the position of “second” of the present time. The constitution is such that, if the push button 382c is pressed for 3 seconds or more, the second hand 290 can be adjusted to the position of 12 o'clock. Next, the push button 382d is pressed so that the present time is displayed by the hour hand 230, the minute hand 260, and the second hand 290. At this time, the hour hand 230 is rotated from the adjusted position, and moved to the position between an hour scale and another hour scale, corresponding to “minute”. Moreover, the minute hand 260 is rotated from the adjusted position, and moved to the position between a minute scale and another minute scale, corresponding to “second”. In this condition, even if the hand setting stern 110 is moved to the zero step, no operation is performed. In this condition, the hour hand 230, the minute hand 260, and the second hand 290 continue to display the present time.

When the hand setting stem 110 is arranged at the first step, by rotating the hand setting stem 110, the mode display wheel 180 can be rotated. The mode display wheel 180 is rotated so that “SET” is displayed in the window section of the dial. In this condition, the convex curved section being convex outwards in the middle of the mode conductive spring 370 contacts with the “SET pattern” of the circuit block 116. Next, by pressing the push button 382d for 3 seconds or more, the condition is set for setting the time to buzz the alarm. Next, by pressing the push button 382a, the hour motor 210 is driven to adjust the hour hand 230 to the position of “hour” in the time to buzz the alarm. Next, by pressing the push button 382b, the minute motor 240 is driven to adjust the minute hand 260 to the position of “minute” in the time to buzz the alarm. Next, by pressing the push button 382d for 3 seconds or more, the setting the time to buzz the alarm is finished. In this condition, the mode display wheel 180 is rotated so that “AL” is displayed in the window section of the dial. In this condition, the convex curved section being convex outwards in the middle of the mode conductive spring 370 contacts with the “AL pattern” of the circuit block 116. In this condition, the hour hand 230, the minute hand 260, and the second hand 290 display the present time. Next, the hand setting stern 110 is moved to the zero step. In the condition, when the time has come to buzz the alarm, the piezobuzzer driving circuit outputs a piezobuzzer drive signal for driving the piezobuzzer 342, to the piezobuzzer 342. As a result, the piezobuzzer 342 performs.

When it is not necessary to buzz the alarm, the hand setting stern 110 is drawn out to the first step, and the hand setting stem 110 is rotated and the mode display wheel 180 is rotated so that “OFF” is displayed in the window section of the dial. In this condition, the convex curved section being convex outwards in the middle of the mode conductive spring 370 contacts with the “OFF pattern” of the circuit block 116. In this condition, the hour hand 230, the minute hand 260, and the second hand 290 display the present time. In this condition, even if the hand setting stem 110 is moved to the zero step, no operation is performed.

When the mode display wheel 180 is rotated so that “TIME” is displayed in the window section of the dial in order to adjust the hour hand 230, the minute hand 260, and the second hand 290 to the present time, and furthermore, the hand setting stem 110 is rotated so that “OFF” is displayed in the window section of the dial, the hour hand 230, the minute hand 260, and the second hand 290 display the present time. When the mode display wheel 180 is rotated so that “TIME” is displayed in the window section of the dial in order to adjust the hour hand 230, the minute hand 260, and the second hand 290 to the present time, and furthermore, the hand setting stem 110 is rotated and the mode display wheel 180 is rotated so that “AL” is displayed in the window section of the dial, the hour hand 230, the minute hand 260, and the second hand 290 display the present time.

When the hand setting stem 110 is arranged at the first step, by rotating the hand setting stem 110, the mode display wheel 180 is rotated so that “AUX” is displayed in the window section of the dial. In this condition, the convex curved section being convex outwards in the middle of the mode conductive spring 370 contacts with the “AUX pattern” of the circuit block 116. Next, by performing the predetermined operations, operations of other additional functions, for example, chronograph and the like, are started. After the operations of other additional functions are finished, the mode display wheel 180 is rotated so that “OFF” or “AL” is displayed in the window section of the dial. Then the hour hand 230, the minute hand 260, and the second hand 290 display the present time.

### (2) Other Embodiments

In the above embodiment of the present invention, the description of the present invention is for an analog electronic timepiece. However, the present invention may be applied to a digital electronic timepiece, and may be applied to a composite display electronic timepiece including analog display structure and digital display structure. In the above embodiment of the present invention, the description of the present invention is for an electronic timepiece using a battery for a power source. However, the present invention may be applied to an electronic timepiece using a capacitor for a power source, and may be applied to an electronic timepiece using a solar battery for a power source. In the above embodiment of the present invention, the description of the present invention is for an electronic timepiece of a construction where a positive electrode of a battery is earthed to a case back. However, the present invention may be applied to an electronic timepiece of a construction where a negative electrode of the battery is earthed to the case back.

In the above embodiments of the present invention, generally the base resin is polystyrene, polyethylene terephthalate, polycarbonate, polyacetal (polyoxymethylene), polyamide, a modified polyphenylene ether, polybutylene terephthalate, polyphenylene sulfide, polyether ether ketone, or polyether imide. However, other plastics, for example, a thermoplastic resin such as polysulfone, polyether sulphone, polyethylene, nylon 6, nylon 66, nylon 12, polypropylene, ABS plastic, or AS resin, can also be used as the base resin. Moreover, two or more kinds of the abovementioned thermoplastic resins may be mixed to use as the base resin. Furthermore, an additive (antioxidant, lubricant, plasticizer, stabilizer, bulking agent, solvent, or the like) may be blended with the base resin used in this invention.

In the above embodiment of the present invention, the description of the present invention is for a construction where filler containing resin without plating is used. However, the present invention may be applied to a construction where a molded filler containing resin is plated. That is, the conductive spring may be used after molding then plating. Types of plating are for example, gold plating (electroless gold plating), nickel plating (electroless nickel plating), and the like.

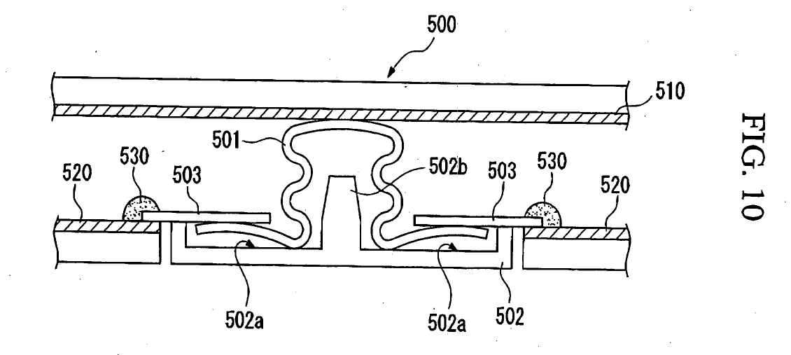

Next is a description of an embodiment of a conductive part of the present invention. Referring to FIG. 10, in the embodiment of the present invention, a conductive part 500 has a conductive spring 501, a first housing 502, and a second housing 503. This conductive part 500 may be a component of a timepiece in the above embodiments. Moreover, the conductive part 500 may be a component of other apparatus not limited to a timepiece.

The conductive spring 501 is constituted to include one or more curved sections so as to be deformable, and the conductive spring 501 is formed from a filler containing resin having a base resin of thermoplastic resin, and carbon filler mixed with this base resin. For the base resin to form this conductive spring 501, the base resin used for the buzzer conductive spring 316 in the above embodiments may be applied. For the carbon filler to fill in this base resin, the carbon filler in the above embodiments may be applied. Here, the conductive spring 501 is a conductive material.

The conductive spring 501 is preferably formed into a “v” shape, a “U” shape, an “Ω”shape, or the like. Or, the conductive spring 501 is preferably formed into a “v” shape having bend sections on both ends, a “U” shape having bend sections on both ends, an “Ω”shape having both ends opened, or the like. The conductive spring 501 is preferably formed into a waveform shape including a convex curved section being convex outwards and a concave curved section being concave outwards.

The first housing 502 and the second housing 503 are for retaining the conductive spring 501. As shown in FIG. 10, the first housing 502 and the second housing 503 are jointed on the end section (or edge section) of the first housing. The first housing 502 may be conductive material or non conductive material. The second housing 503 is a conductive material. Or, only the surface (back face) of the second housing 503 may be a conductive material.

Moreover, a guiding section 502b for guiding the conductive spring 501 is provided in the first housing 502. A recessed section 502a for clearance from both ends of the conductive spring 501 is provided in the first housing 502. The guiding section 502b may be cylindrical, conical, truncated conical, or quadratic prism. The conductive spring 501 can be reliably located by providing the guiding section 502b.

Furthermore, as shown in FIG. 10, the construction is such that the end section of the conductive spring 501 or the curved section near the end section of the conductive spring 501 contacts with the second housing 503. Therefore, the conductive spring 501 and the second housing 503 are electrically connected.

Next is a description of the usage and the operation of the conductive part 500 of the above configuration. The conductive part 500 is mounted in a timepiece or other various apparatus (hereunder, apparatus). In this mounting operation, the conductive part 500 is installed so that a convex curved section being convex outwards in the middle of the conductive spring 501 is arranged near a pattern (first pattern) 510 for transferring signals (or for supplying power) in the apparatus. This first pattern may be formed, for example, on a piezoelectric element (buzzer), a case back, or other substrate.

Here, the first pattern is movable being linked with operations such as pressing a switch for example. Therefore, for example, by pressing the switch, the first pattern is moved to contact with the convex curved section of the conductive spring 501 so that the first pattern and the conductive spring 501 are electrically connected.

Moreover, in the above mounting operation, the conductive part 500 is installed so that the second housing 503 contacts and electrically connects with a pattern (second pattern) 520 for transferring signals (or for supplying power) in the apparatus. For example, the end section of the second housing 503 and the second pattern 520 are jointed by a conductive material 530 such as a solder.

Therefore, by pressing the switch, the first pattern 510 is electrically connected to the second pattern 520 through the conductive spring 501 and the second housing 503. Therefore, the mounted conductive part 500 can open and close a signal transfer route (or a power supply route or the like) between the first pattern 510 and the second pattern 520.

Since the conductive spring 501 in the conductive part 500 is formed from a filler containing resin, the conductive spring is not buckled, the other parts are not damaged, and the conducting performance is stable.

Next is a description of an example of experimental data showing that the buzzer conductive spring 316, the mode conductive spring 370, and the conductive spring 501 formed from a carbon filler containing resin, have conductivity in the above embodiments, with reference to TABLE 1. TABLE. 1 shows the conductive characteristic of polycarbonate resin (PC) or polybutyrene terephthalate resin (PBT) with a carbon filler of 3.5% or 5% by weight added, and polyamide resin 12 (PA12) with a carbon filler of 20% by weight added, that is a carbon filler containing resin. The characteristics of non-composite materials with carbon filler not added (that is, PC, PBT, PA12 itself) are shown as “BLANK” for comparison.

The experimental data shown in TABLE. 1 is measured according to the standard D257 of the American Society for Testing and Materials (ASTM). This standard D257 is a normal experimental method for measuring conductance and the like.

Here, the conductive material is defined such that the surface resistance (Ω/□) is in a range of 10⁻³ to 10⁶, or the volume resistivity (Ω·cm) is in a range of 10⁻³ to 10⁶, or both are satisfied.

As shown in TABLE. 1, the surface resistance (Ω/□) and the volume resistivity (Ω·cm) of the various resins with a carbon filler added were significantly decreased compared to the various resins with carbon filler not added (BLANK). That is, the various resins with a carbon filler added became conductive materials. Moreover, the surface resistance (Ω/□) and the volume resistivity (Ω·cm) of PC and PBT with a carbon filler of 5% by weight added were lower and the conductance was improved compared to PC and PBT with a carbon filler of 3.5% by weight added. Furthermore, the surface resistance (Ω/□) and the volume resistivity (Ω·cm) of PA12 with a carbon filler added were significantly decreased compared to PA12 with carbon filler not added (BLANK). That is, PA12 with a carbon filler added became a conductive material. From the above, it was found that the more carbon filler added, the more the conductance was improved. However, if the carbon filler added was too much, the resin became fragile.

Therefore, by using a resin with a carbon filler of 20% to 3.5% by weight added, it becomes possible to provide a buzzer conductive spring 316, a mode conductive spring 370, a conductive spring 501, and the like which is not buckled, wherein the other parts are not damaged, and the conducting performance is stable.

### INDUSTRIAL APPLICABILITY

In the electronic timepiece of the present invention, the conductive spring is not buckled, the other parts are not damaged, and the conducting performance is stable. The conductive spring of the present invention is not buckled, the other parts are not damaged, and it has a reliable conducting performance. In the conductive part of the present invention, the conductive spring is not buckled, the other parts are not damaged, and the conducting performance is stable.

TABLE 1

| | Method of | | PC | | | PBT | | | PA12 | |
|---|---|---|---|---|---|---|---|---|---|---|
| Item | measuring | Units | 5 wt % | 3.5 wt % | BLANK | 5 wt % | 3.5 wt % | BLANK | 20 wt % | BLANK |
| Surface resistance | ASTM D-257 | Ω/□ | 10⁵ | 10⁶ | — | 10³ | 10⁷ | 10¹² | 10⁰ | 10¹⁴ |
| Volume | ASTM D-257 | Ω · cm | 10² | 10⁵ | 10¹⁷ | 10¹ | 10² | 10¹⁴ | 10⁰ | 10¹⁴ |
| resistance | | | | | | | | | | |

1. An electronic timepiece being constituted to notify by a piezobuzzer arranged inside of a case back of an exterior case, comprising:
a buzzer signal transferring conductive spring for electrically connecting a signal output pattern on a circuit block and a signal input pattern on the piezobuzzer,
wherein said conductive spring is constituted to include one or more curved sections so as to be deformable, and
said conductive spring is formed from a filler containing resin having a base resin of thermoplastic resin, and carbon filler mixed with this base resin.

2. An electronic timepiece being constituted to display a mode by a rotatable mode display wheel, comprising:
a mode setting conductive spring for electrically connecting a signal input pattern on a circuit block and said mode display wheel which is constituted by a conductive material,
wherein said conductive spring is constituted to include one or more curved sections so as to be deformable, and
said conductive spring is formed from a filler containing resin having a base resin of thermoplastic resin, and carbon filler mixed with this base resin.

3. An electronic timepiece having an exterior case including a case back, comprising:
an earth conductive spring for electrically connecting an electrode on one side of a power source and said case back which is formed from a conductive material,
wherein said conductive spring is constituted to include one or more curved sections so as to be deformable, and
said conductive spring is formed from a filler containing resin having a base resin of thermoplastic resin, and carbon filler mixed with this base resin.

4. An electronic timepiece according to any one of claim 1 through claim 3,
wherein said base resin is selected from a group consisting of: polystyrene, polyethylene terephthalate, polycarbonate, polyacetal (polyoxymethylene), polyamide, modified polyphenylene ether, polybutylene terephthalate, polyphenylene sulfide, polyether ether ketone, and polyether imide.

5. An electronic timepiece according to any one of claim 1 through claim 4,
wherein said carbon filler is selected from a group consisting of: a monolayer carbon nanotube, a multilayer carbon nanotube, a vapor grown carbon fiber, a nanografiber, a carbon nanohorn, a cup stack type carbon nanotube, a monolayer fullerene, a multilayer fullerene, and a mixture of any one of the carbon fillers doped with boron.

6. (canceled)

7. (canceled)

8. (canceled)

9. (canceled)

10. (canceled)

11. (canceled)
